(19) United States
(12) Patent Application Publication
(10) Pub. No.: US 2013/0049721 A1
(43) Pub. Date: Feb. 28, 2013

(54) Linear Regulator and Control Circuit Thereof

(71) Applicants: CHIEH-MIN LO, Zhunan Township (TW); Tzu-Huan Chiu, Taichung City (TW)

(72) Inventors: CHIEH-MIN LO, Zhunan Township (TW); Tzu-Huan Chiu, Taichung City (TW)

(73) Assignee: Richtek Technology Corporation, R.O.C.

(21) Appl. No.: 13/538,384

(22) Filed: Jun. 29, 2012

(30) Foreign Application Priority Data
Aug. 29, 2011 (TW) 100216094

(51) Int. Cl. G05F 1/10

(52) U.S. Cl. 323/280

(57) ABSTRACT

The present invention discloses a linear regulator and a control circuit therefor. The linear regulator includes: a power device coupled between an input voltage and an output voltage; a first error amplifier including a depletion NMOS differential circuit comparing a feedback signal related to the output voltage with a reference signal; a second error amplifier including a native NMOS differential circuit comparing the feedback signal with the reference signal; and a start-up circuit which enables the first error amplifier to dominate control and drive the power device when the linear regulator is at a first stage of a start-up period and enables the second error amplifier to dominate control and drive the power device when the linear regulator is at a second stage after the first stage.

### CROSS REFERENCE

The present invention claims priority to TW 100216094, filed on Aug. 29, 2011.

### BACKGROUND OF THE INVENTION

1. Field of Invention

The present invention relates to a linear regulator and a control circuit, in particular to such linear regulator and control circuit capable of avoiding a large inrush current at the beginning of a start-up period.

2. Description of Related Art

Atypical sample of the linear regulator is an LDO (low drop-out) circuit. FIG. 1 shows a schematic diagram of a prior art LDO circuit 10. The resistors R1 and R2 compose a voltage divider 16. The feedback signal FB is extracted from the voltage difference across the resistor R2, and is compared with a reference voltage Vref by an error amplifier 12. The error amplifier 12 outputs a signal to control a power device 14 for converting an input voltage Vin to an output voltage Vout and charging a capacitor Cout.

The foregoing LDO circuit has a disadvantage: a large inrush current occurs at the beginning of a start-up period. Such sudden current causes serious noises and severe electromagnetic interference (EMI) which affect the normal operation of peripheral circuits. Moreover, electrical overstress (EOS) also occurs which may damage circuit components.

To suppress the negative effects of the aforementioned inrush current, a conventional solution is to add a soft-start circuit to the LDO circuit. FIG. 2 illustrates an LDO circuit 20 disclosed by U.S. Pat. No. 7,466,115. The LDO circuit 20 comprises a power device 14, an error amplifier 22, a divider circuit 15, and a soft-start circuit 28. When the LDO circuit 20 just starts up, the soft-start circuit 28 selects the voltage V2 as the reference voltage Vref. After the feedback voltage FB exceeds the voltage V2, the soft start circuit 28 switches to the voltage V_{BG}, and provides the voltage V_{BG} as the reference voltage Vref. The LDO circuit 20 operates according to the voltage V_{BG} to complete the remaining rising portion of the output voltage Vout, so it can prevent the output voltage Vout from rising abruptly. However, such soft-start circuit 28 is quite complicated, and the switching consumes much power.

To meet the above requirement for suppressing the inrush current, the present invention provides a linear regulator and a control circuit thereof in a very different way. The large inrush current can be eliminated at the beginning of a start-up period. Moreover, such a circuit does not need a large chip area.

### SUMMARY OF THE INVENTION

An objective of the present invention is to provide a linear regulator.

Another objective of the present invention is to provide a control circuit of a linear regulator.

To achieve the foregoing objectives, in one aspect, the present invention provides a linear regulator comprising: a power device coupled between an input voltage and an output voltage; a first error amplifier including a depletion NMOS differential circuit comparing a feedback signal related to the output voltage with a reference signal; a second error amplifier including a native NMOS differential circuit comparing the feedback signal with the reference signal; and a start-up circuit which enables the first error amplifier to dominate control and drive the power device when the linear regulator is at a first stage of a start-up period and enables the second error amplifier to dominate control and drive the power device when the linear regulator is at a second stage after the first stage.

In one embodiment of the foregoing linear regulator, the start-up circuit enables the first error amplifier at the first stage and disables the first error amplifier at the second stage.

In one embodiment of the foregoing linear regulator, both the first error amplifier and the second error amplifier operate at the first stage.

In one embodiment of the foregoing linear regulator, the start-up circuit includes: a depletion NMOS transistor including a drain coupled to the input voltage, a gate, and a source coupled to the gate; and an enhancement NMOS transistor including a drain coupled to the source of the depletion NMOS transistor, a gate coupled to the feedback signal, and a source coupled to ground. Preferably, the start-up circuit further includes a buffer gate having an input terminal coupled to the source of the depletion NMOS transistor, and an output terminal providing an output signal of the start-up circuit.

In yet another aspect, the present invention provides a control circuit for controlling a linear regulator to convert an input voltage to an output voltage, the control circuit comprising: a first error amplifier including a depletion NMOS differential circuit comparing a feedback signal related to the output voltage with a reference signal; a second error amplifier including a native NMOS differential circuit comparing the feedback signal with the reference signal; and a start-up circuit which enables the first error amplifier to dominate control and drive the voltage conversion when the linear regulator is at a first stage of a start-up period and enables the second error amplifier to dominate control and drive the voltage conversion when the linear regulator is at a second stage after the first stage.

The objectives, technical details, features, and effects of the present invention will be better understood with regard to the detailed description of the embodiments below, with reference to the drawings.

### BRIEF DESCRIPTION OF THE DRAWINGS

FIG. 1 shows a schematic diagram of a prior art LDO circuit.

FIG. 2 illustrates the LDO circuit disclosed by U.S. Pat. No. 7,466,115.

FIG. 3 shows a schematic diagram of an embodiment of the present invention, illustrating a linear regulator.

FIG. 4 shows a schematic diagram of another embodiment of the present invention, illustrating a linear regulator.

FIG. 5 shows a schematic diagram of an embodiment of the present invention, illustrating a start-up circuit.

FIG. 6 shows a schematic diagram of another embodiment of the present invention, illustrating a linear regulator.

### DESCRIPTION OF THE PREFERRED EMBODIMENTS

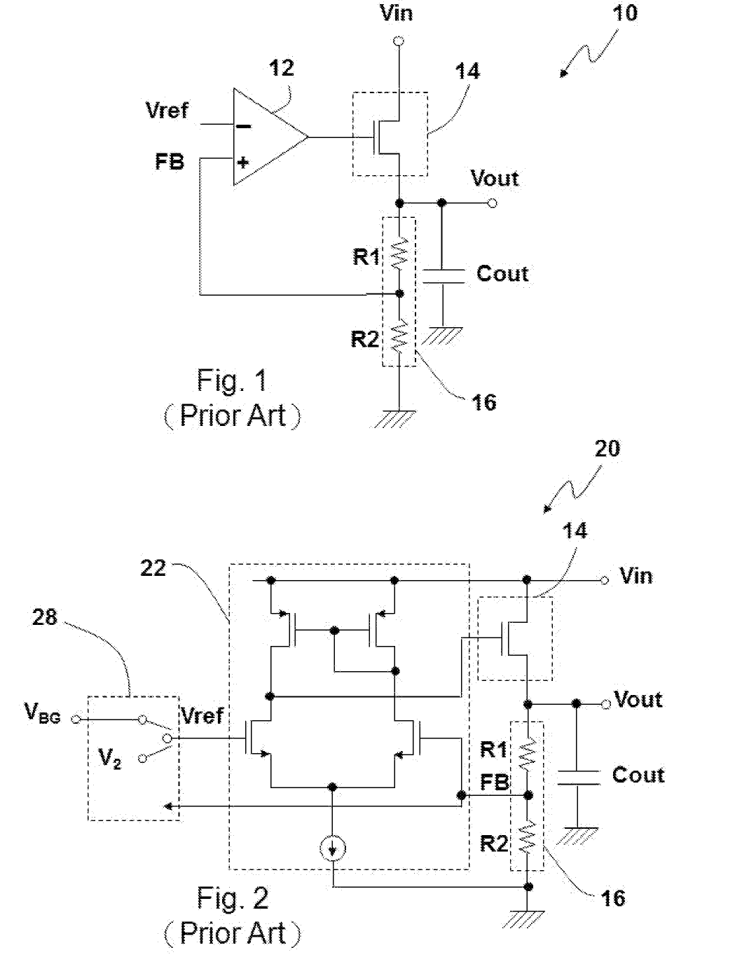

As shown by FIG. 1, a linear regulator comprises an error amplifier. The error amplifier includes a differential pair of transistors. In the prior art circuits, the differential pair of transistors are enhancement transistors. The present invention proposes: if the differential pair of transistors are replaced by depletion transistors, the problem of large inrush current can be resolved because of the current limiting effect of the depletion transistor. However, when the depletion transistor is turned ON, the gate to source voltage is negative and the drain voltage is about the same as the source voltage. In other words, the headroom of the reference voltage of the error amplifier is restricted by the characteristics of the depletion transistor, that is, the input voltage of the linear regulator is restricted below a certain level. Thus, it cannot regulate a higher input voltage.

On the other hand, if native transistors are used to build the error amplifier, because the threshold voltage of a native transistor is lower than that of a normal enhancement transistor, the error amplifier can operate at a lower range, and the headroom is expanded because the lower limit extends downward. Thus, a linear regulator using an error amplifier of native transistors can regulate a lower input voltage. However, the characteristics of the native transistor are similar to those of the enhancement transistor, so the problem of the large inrush current still exists.

In view of the above, the basic concept of the present invention is: that the linear regulator employs two differential pairs of transistors, and they are respectively formed by depletion transistors and native transistors. When the circuit just starts up and the feedback signal is at a lower level, an error amplifier of depletion transistors controls the conversion from the input voltage to the output voltage so as to avoid the inrush current. After the initial start-up, when the feedback signal is closer to the level of the reference signal, an error amplifier of native transistors is subsequently takes over to control the conversion from the input voltage to the output voltage, and the linear regulator is capable of regulating a lower input voltage.

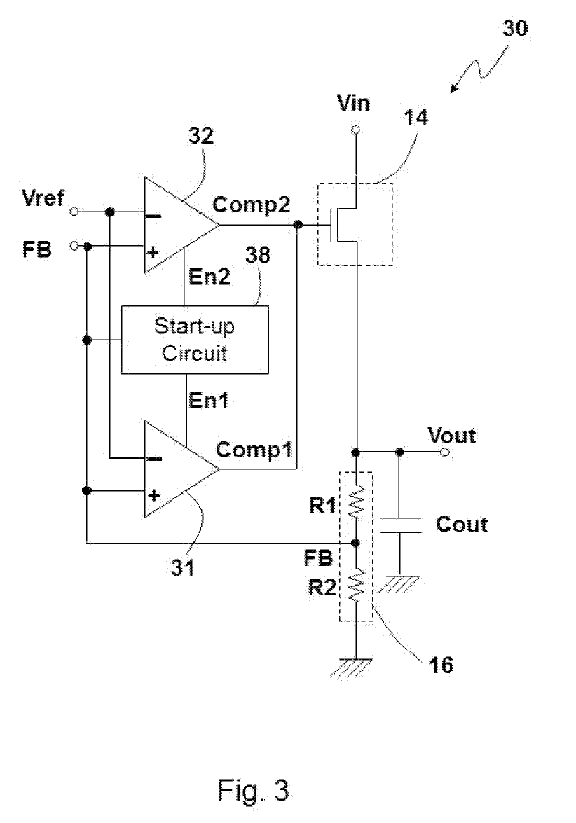

FIG. 3 shows a schematic diagram of an embodiment of the present invention, illustrating a linear regulator. As shown in this figure, the linear regulator 30 comprises a power device 14, a first error amplifier 31, a second error amplifier 32, a divider circuit 16 and a start-up circuit 38. The first error amplifier 31 includes a differential pair of depletion transistors, and the second error amplifier 32 includes a differential pair of native transistors. The start-up circuit 38 can generate operation signals (En1, En2) to enable or disable the first error amplifier 31 and/or the second error amplifier 32. The power device 14 converts an input voltage Vin into an output voltage Vout according to the output signals of the first error amplifier 31 and/or the second error amplifier 32, and charges a capacitor Cout. The first error amplifier 31 compares a feedback signal FB with a reference signal Vref to generate a first error signal Comp1. Similarly, the second error amplifier 32 compares the feedback signal FB with the reference signal Vref to generate a second error signal Comp2.

When the linear regulator 30 is at a first (earlier) stage of a start-up period, the first operation signal Ent enables the first error amplifier 31, and the first error signal Comp1 generated by the first error amplifier 31 dominates the control of the power device 14. In this first stage, the output voltage Vout begins to rise from a zero level, and the feedback signal FB extracted from the divider circuit 16 also rises from a zero level. When the feedback signal FB is higher than a threshold value, the linear regulator 30 enters a second (later) stage, and the second error signal Comp2 generated by the second error amplifier 32 dominates the control of the power device 14.

When the first error amplifier 31 is controlling the power device 14 at the first stage, the second error amplifier 32 can either be disabled or also enabled. In the latter case, although the second error amplifier 32 also operates at the first stage, because the first error amplifier 31 of depletion transistors responses faster than the second error amplifier 32 of native transistors during the start-up period, the first error amplifier 31 still dominates the control of the power device 14. When the second error amplifier 32 takes over to control the power device 14 at the second stage, the first error amplifier 31 can be disabled, or it can be arranged so that the second error signal Comp2 overrides the first error signal Comp1, so that the second error amplifier 32 dominates the control of the power device 14.

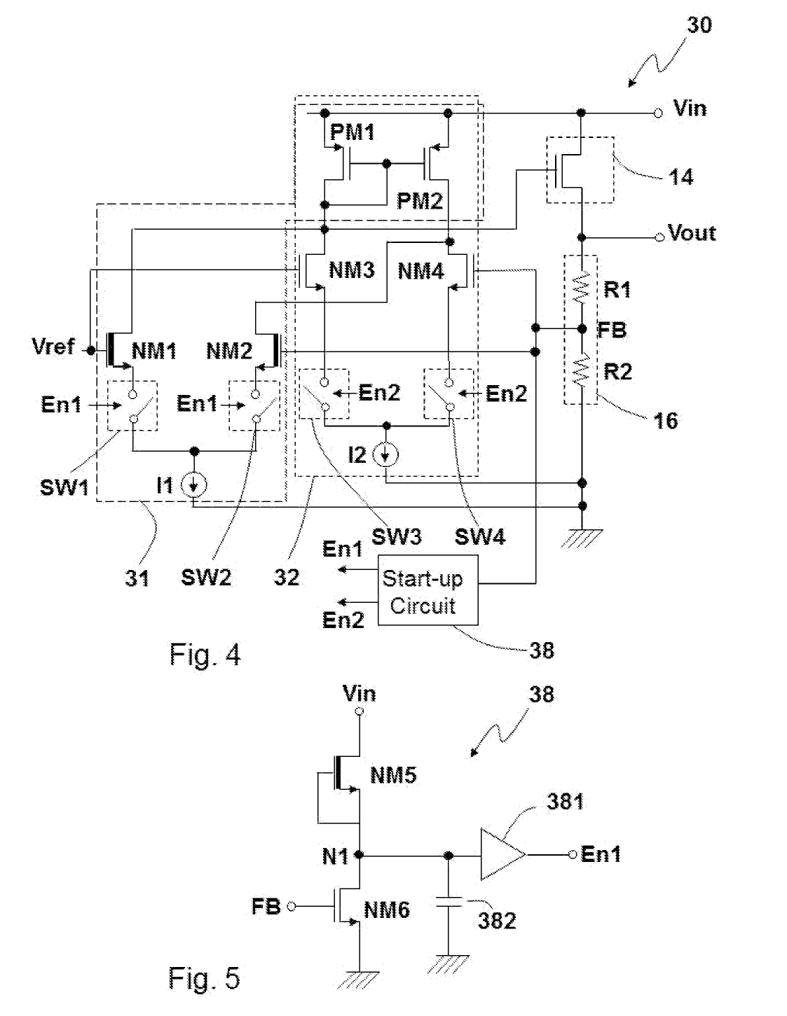

FIG. 4 shows a schematic diagram of another embodiment of the present invention, illustrating a linear regulator. As shown in this figure, the first error amplifier 31 includes a differential pair of depletion NMOS transistors (NM1, NM2) and a first current source I1. The second error amplifier 32 includes a differential pair of native NMOS transistors (NM3, NM4) and a second current source I2. In addition, the first error amplifier 31 and the second error amplifier 32 are connected to a common load circuit. For example, the load circuit includes a pair of enhancement PMOS transistors PM1 and PM2, and the sources of the two transistors PM1 and PM2 are coupled to the input voltage Vin. The differential pair of the first error amplifier 31 compares the feedback signal FB with the reference signal Vref to generate a first error signal Comp1. Similarly, the differential pair of the second error amplifier 32 compares the feedback signal FB with the reference signal Vref to generate a second error signal Comp2.

The start-up circuit 38 generates a first operation signal En1 and a second operation signal En2 to control switches (SW1, SW2, SW3, SW4), respectively. The switches SW1 and SW2 are controlled by the first operation signal En1, and the switches SW3 and SW4 are controlled by the second operation signal En2. At the earlier first stage of the start-up period, the first operation signal En1 turns ON the switches SW3 and SW4 to enable the first error amplifier 31, so that the first error amplifier 31 dominates the control of the power device 14. At the later second stage of the start-up period, the second operation signal En2 turns ON the switches SW3 and SW4 to enable the second error amplifier 32, so that the second error amplifier 32 dominates the control of the power device 14. In one embodiment, the first operation signal En1 and the second operation signal En2 may be (but not limited to) two signals with opposite phases. As aforementioned, when one of the first error amplifier 31 and the second error amplifier 32 is designated to dominate the control of the power device 14, the other one may be disabled, but this is not a must.

There are many ways for start-up circuit 38 to determine generation of the first operation signal En1 and/or the second operation signal En2. For example, the feedback signal FB can be compared with a predetermined reference level. When the feedback signal FB is below the reference level, the first operation signal En1 is generated to turn ON the switches SW1 and SW2. When the feedback signal FB rises above the reference level, the second operation signal En2 is generated to turn ON the switches SW3 and SW4. Or, according to a POR (power-on-reset) signal which is typically generated in a circuit at its start-up, the first operation signal En1 is generated in response to the POR signal to turn ON the switches SW1 and SW2. The second operation signal En2 is generated to turn ON the switches SW3 and SW4 after a certain delay. FIG. 5 shows another embodiment of the start-up circuit 38. This embodiment employs less number of devices to achieve the foregoing start-up control function.

As shown in FIG. 5, the start-up circuit 38 includes a depletion NMOS transistor NM5, an enhancement NMOS transistor NM6, and a buffer gate 381. When the circuit starts up, there is no voltage on the gate of the depletion NMOS transistor NM5, so its channel is conductive. The input voltage Vin feeds currents to a node N1 through the depletion NMOS transistor NM5. The potential of the node N1 accordingly rises to a high level, and consequently the buffer gate 381 changes its output status to trigger the regulator to enter the first stage of the start-up period. The output En 1 of the buffer gate 381 turns ON the switches SW1 and SW2. The buffer gate can be an inverting or non-inverting buffer gate, depending on the type of the switches SW1 and SW2. The second operation signal En2 maybe an inverting signal of the signal En1. Or, The second operation signal En2 may be the same as the first operation signal En1, and the switches SW1 and SW2 and the switches SW3 and SW4 have opposite types. The feedback signal FB rises as the output voltage rises. When the feedback signal FB exceeds a threshold value (in this embodiment, the threshold value corresponds to the threshold voltage of the enhancement NMOS transistor NM6), the channel of the enhancement NMOS transistor NM6 becomes conductive and the potential of the node N1 falls to a low level because the output En1 of the buffer gate 381 changes its status again. Thus, the linear regulator enters the second stage, and the output En1 of the buffer gate 381 turns OFF the switches SW1 and SW2. The embodiment is only one example of the start-up circuit 38. As aforementioned, depending on the design of the switches (SW1, SW2, SW3, SW4), the type, the number, the connection relation of the transistors can be modified as long as the required control at the first stage and the second stage is achieved. As shown in this figure, a capacitor 382 can be optionally disposed between the input terminal of the buffer gate 381 and the ground (or any node with a proper potential) . The function of the capacitor is to determine the level switching delay time of the buffer gate 381 by adjusting its capacitance.

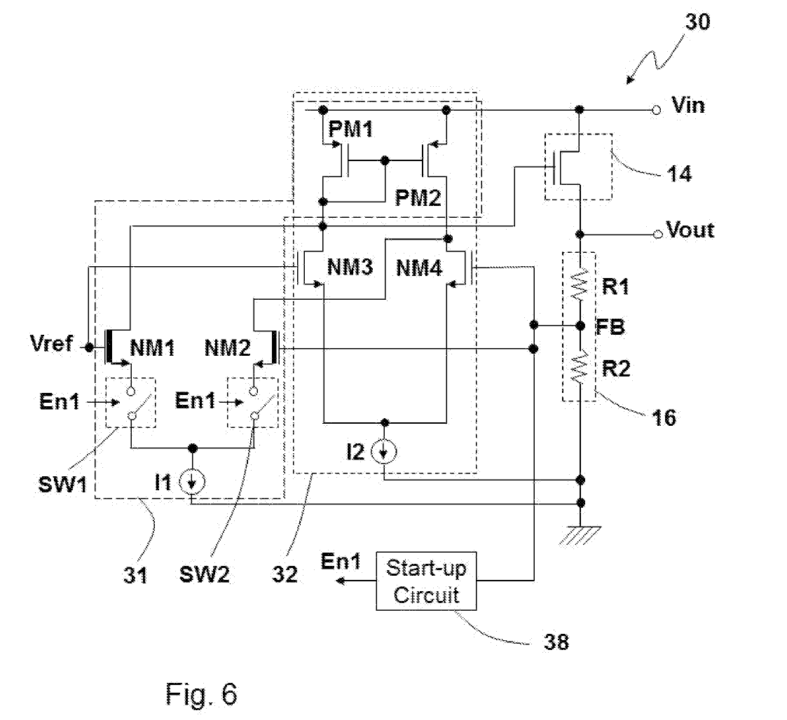

FIG. 6 shows a schematic diagram of another embodiment of the present invention. The second error amplifier 32 of the embodiment does not include the switches SW3 and SW4, so the circuit can be further simplified. At the first stage of the start-up period, both the first error amplifier 31 and the second error amplifier 32 operate. The output voltage Vout is low, so the feedback signal FB is also at a very low level. The depletion differential pair of the first error amplifier 31 has a faster response time so it starts to operates, while the native differential pair of the second error amplifier 32 has a slower response time so it is not yet in full operation. Thus, the first error amplifier 31 dominates the control at the first stage of the start-up period. When the voltage of the feedback signal FB rises above a threshold value, the start-up circuit 38 turns OFF the switches SW1 and SW2, and the first error amplifier 31 is disabled. The second error amplifier 32 takes over to control the power device 14. This embodiment also can achieve the objectives of the present invention. In comparison with the previous embodiment of FIG. 4, the present embodiment omits the switches SW3 and SW4, and the start-up circuit 38 only needs to output the first operation signal En1 but does not need to output the second operation signal En2.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, if a proper potential can be generated at the node N1 of the start-up circuit, then the buffer gate 381 can be omitted. For another example, a device or circuit which does not affect the major functions of the signals, such as a switch, etc., can be added between two circuits illustrated to be directly connected with each other. Thus, the present invention should cover all such and other modifications and variations, which should be interpreted to fall within the scope of the following claims and their equivalents.

What is claimed is:

1. A linear regulator, comprising:
a power device coupled between an input voltage and an output voltage;
a first error amplifier including a depletion NMOS differential circuit comparing a feedback signal related to the output voltage with a reference signal;
a second error amplifier including a native NMOS differential circuit comparing the feedback signal with the reference signal; and
a start-up circuit which enables the first error amplifier to dominate control and drive the power device when the linear regulator is at a first stage of a start-up period and enables the second error amplifier to dominate control and drive the power device when the linear regulator is at a second stage after the first stage.

2. The linear regulator of claim 1, wherein the start-up circuit enables the first error amplifier at the first stage and disables the first error amplifier at the second stage.

3. The linear regulator of claim 2, wherein both the first error amplifier and the second error amplifier operate at the first stage.

4. The linear regulator of claim 1, wherein the start-up circuit includes:
a depletion NMOS transistor including a drain coupled to the input voltage, a gate, and a source coupled to the gate; and
an enhancement NMOS transistor including a drain coupled to the source of the depletion NMOS transistor, a gate coupled to the feedback signal, and a source coupled to ground.

5. The linear regulator of claim of claim 4, wherein the start-up circuit includes a buffer gate having an input terminal coupled to the source of the depletion NMOS transistor, and an output terminal providing an output signal of the start-up circuit.

6. The linear regulator of claim 5, wherein the start-up circuit further comprises a capacitor coupled between the input terminal of the buffer gate and a node having a potential different from the potential of the input terminal, for adjusting a level switching delay time of an output signal of the buffer gate.

7. A control circuit for controlling a linear regulator to convert an input voltage to an output voltage, the control circuit comprising:
a first error amplifier including a depletion NMOS differential circuit comparing a feedback signal related to the output voltage with a reference signal;
a second error amplifier including a native NMOS differential circuit comparing the feedback signal with the reference signal; and
a start-up circuit which enables the first error amplifier to dominate control and drive the voltage conversion when the linear regulator is at a first stage of a start-up period and enables the second error amplifier to dominate control and drive the voltage conversion when the linear regulator is at a second stage after the first stage.

8. The control circuit of a linear regulator of claim 7, wherein the first error amplifier and the second error amplifier are connected to a same load circuit.

9. The control circuit of a linear regulator of claim 7, wherein the start-up circuit enables the first error amplifier at the first stage and disables the first error amplifier at the second stage.

10. The control circuit of a linear regulator of claim 9, wherein both the first error amplifier and the second error amplifier operate at the first stage.

11. The control circuit of a linear regulator of claim 7, wherein the start-up circuit includes:
a depletion NMOS transistor including a drain coupled to the input voltage, a gate, and a source coupled to the gate; and
an enhancement NMOS transistor including a drain coupled to the source of the depletion NMOS transistor, a gate coupled to the feedback signal, and a source coupled to ground.

12. The control circuit of a linear regulator of claim 11, wherein the start-up circuit includes a buffer gate having an input terminal coupled to the source of the depletion NMOS transistor, and an output terminal providing an output signal of the start-up circuit.

13. The control circuit of a linear regulator of claim 12, wherein the start-up circuit further comprises a capacitor coupled between the input terminal of the buffer gate and a node having a potential different from the potential of the input terminal, for adjusting a level switching delay time of an output signal of the buffer gate.
